(19) United States
(12) Patent Application Publication
(10) Pub. No.: US 2023/0262059 A1
(43) Pub. Date: Aug. 17, 2023

(54) SYSTEM AND METHODS FOR SECURE VALIDATION OF UNRESTRICTED RESOURCE DISTRIBUTION

(71) Applicant: BANK OF AMERICA CORPORATION, Charlotte, NC (US)

(72) Inventors: Bikash Dash, Hyderabad (IN); Meera Lakshmi, Chennai (IN)

(73) Assignee: BANK OF AMERICA CORPORATION, Charlotte, NC (US)

(21) Appl. No.: 17/674,018

(22) Filed: Feb. 17, 2022

(51) Int. Cl. H04L 9/40; H04L 47/762; H04L 47/78; G06K 9/62; G06N 20/00

(52) U.S. Cl. CPC H04L 63/0876; H04L 63/20; H04L 47/762; H04L 47/781; G06K 9/6256; G06N 20/00

(57) ABSTRACT

Embodiments of the invention are directed to systems, methods, and computer program products for dynamically altering pre-defined threshold restrictions for resource distributions, depending on results of analysis of one or more user environment factors. The invention is generally comprised of a deployable layer of intelligent models trained to response to user situations where unrestricted resource distribution may be allowed. The resulting service has ability to effectively authorize resource distribution and provide increased convenience for the user.

### FIELD

The present invention generally relates to the field of dynamic solutions for secure and convenient resource transfer.

### BACKGROUND

With the increased use remote payment networks, there is a need for a system and methods which recognize, account for, and automate solutions for secure authorization in resource transfer processing, while still allowing for appropriate response to situational needs of a user. Additionally, there may be instances where users may require resource amounts above pre-set thresholds typically used to limit remote resource transactions. A solution is needed which can intelligently identify exceptions to such thresholds to provide a more convenient and effective user experience.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The systems and methods described herein address the above needs by providing an innovative solution for secure validation for unrestricted resource distribution. The invention is generally comprised of multiple systems and components which work together to provide intelligent response, validation, and authorization for situationally dependent resource or account transfer requirements. The resulting service has ability to integrate with one or more available user devices in order to analyze a user's environment, and determine expedited approval for resource transfers that may be above a typical pre-set threshold limit. An artificial intelligence (AI) model captures details for each multiple resource transfers, user experiences, situational demands, network environment, or the like, and applies a machine learning algorithm to determine the overall nature and security of the user's situation, as well as intelligently validate the user's identity and authorization level to initiate transactions. The AI model, using deep learning, trains on a data set of test resource transfers until a high degree of accuracy is achieved. Results for later resource transfers are then evaluated and the model is improved with up to date resource transfer details to ensure the AI model remains accurate in identifying instances where unrestricted resource transfer should be allowed, or can be safely allowed. Additionally, integration with nearby user devices may allow the user to communicate with the system or utilize the system in a range of modes of communication, providing increased convenience.

The systems, methods, and computer program products of the present invention generally include the steps of: receive a request from a user device to validate a resource distribution; forward one or more request attributes to a validation engine for pattern recognition and resource distribution authentication; analyze and compare the one or more request attributes via the validation engine to determine if the resource distribution is partially or fully validated based on comparison to historical user or device data and one or more contextual validation factors; and based on determining that the resource distribution is partially or fully validated, automatically process the resource distribution via a secure web gateway.

In some embodiments, the invention is further configured to determine that the resource distribution is above a pre-defined threshold limit for automatic processing prior to initiating further processing via the validation engine.

In some embodiments, the user device is an internet-of-things device, such as a smart home assistant, home appliance, or entertainment device.

In some embodiments, the request attributes further comprise a resource amount, a resource recipient, a frequency of repetition, a user resource account, a resource distribution channel, and a resource type.

In some embodiments, the invention is further configured to transmit a notification to the user device upon a determination that the resource distribution is partially or fully validated.

In some embodiments, the invention is further configured to determine that the resource distribution is above a pre-defined amount threshold prior to validation; and remove the pre-defined threshold based on determining that the resource distribution is partially or fully validated.

In some embodiments, the validation engine is a machine learning model trained to conduct image validation.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates a system environment for secure validation of unrestricted resource distribution, in accordance with one embodiment of the present disclosure;

FIG. 2 is a block diagram illustrating components of the secure resource system, in accordance with one embodiment of the present disclosure;

FIG. 3 is a block diagram illustrating a user device associated with the secure resource system, in accordance with one embodiment of the present disclosure; and

FIG. 4 is a process flow diagram illustrating a process for secure validation of unrestricted resource distribution, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” or “managing entity” as used herein may refer to any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, or the like. The account is associated with and/or maintained by the entity. In other embodiments, an entity may not be a financial institution. In still other embodiments, the entity may be the merchant itself.

“Entity system” or “managing entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“User” as used herein may refer to an individual associated with an entity. As such, in some embodiments, the user may be an individual having past relationships, current relationships or potential future relationships with an entity. In some instances, a “user” is an individual who has a relationship with the entity, such as a customer or a prospective customer. Accordingly, as used herein the term “user device” or “mobile device” may refer to mobile phones, personal computing devices, tablet computers, wearable devices, and/or any portable electronic device capable of receiving and/or storing data therein and are owned, operated, or managed by a user.

“Transaction” or “resource transfer” as used herein may refer to any communication between a user and a third party merchant or individual to transfer funds for purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

The system allows for use of a machine learning engine to intelligently identify patterns in received resource transaction data. The machine learning engine may be used to analyze historical data in comparison to real-time received transaction data in order to identify transaction patterns or potential issues. The machine learning engine may also be used to generate intelligent aggregation of similar data based on metadata comparison resource transaction characteristics, which in some cases may be used to generate a database visualization of identified patterns similarities.

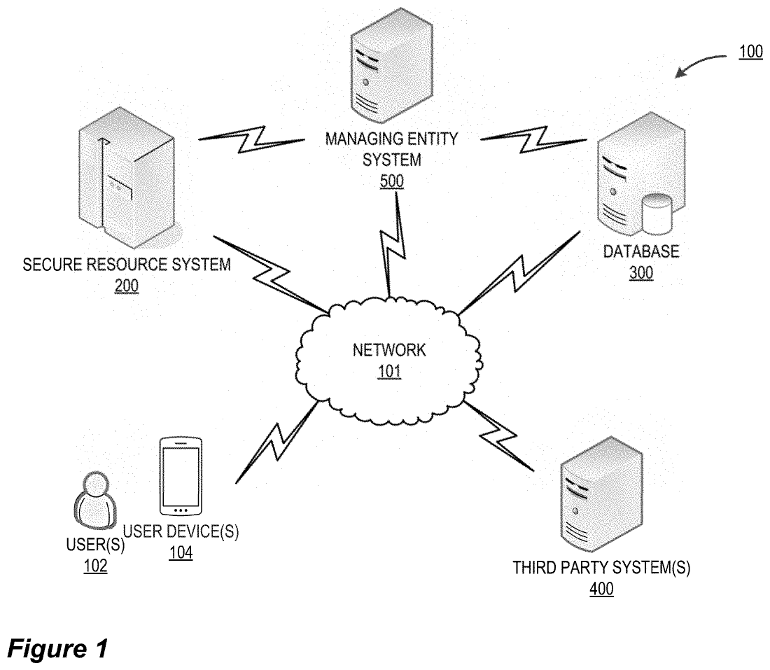

FIG. 1 illustrates an operating environment for secure validation of unrestricted resource distribution, in accordance with one embodiment of the present disclosure. As illustrated, the operating environment 100 may comprise user 102 and/or user device(s) 104 in operative communication with one or more third party systems 400 (e.g., web site hosts, registry systems, financial entities, third party entity systems, merchant systems, retailers, distributors, or the like). The operative communication may occur via a network 101 as depicted, or the user 102 may be physically present at a location separate from the various systems described, utilizing the systems remotely. The operating environment also includes a managing entity system 500, secure resource system 200, a database 300, and/or other systems/devices not illustrated herein and connected via a network 101. As such, the user 102 may request information from or utilize the services of the secure resource system 200, or the third party system 400 by establishing operative communication channels between the user device 104, the managing entity system 500, and the third party system 400 via a network 101.

Typically, the secure resource system 200 and the database 300 are in operative communication with the managing entity system 500, via the network 101, which may be the internet, an intranet, or the like. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user device 104 and the third party system 400). In this regard, the wireless communication channel may further comprise near field communication (NFC), communication via radio waves, communication through the internet, communication via electromagnetic waves and the like.

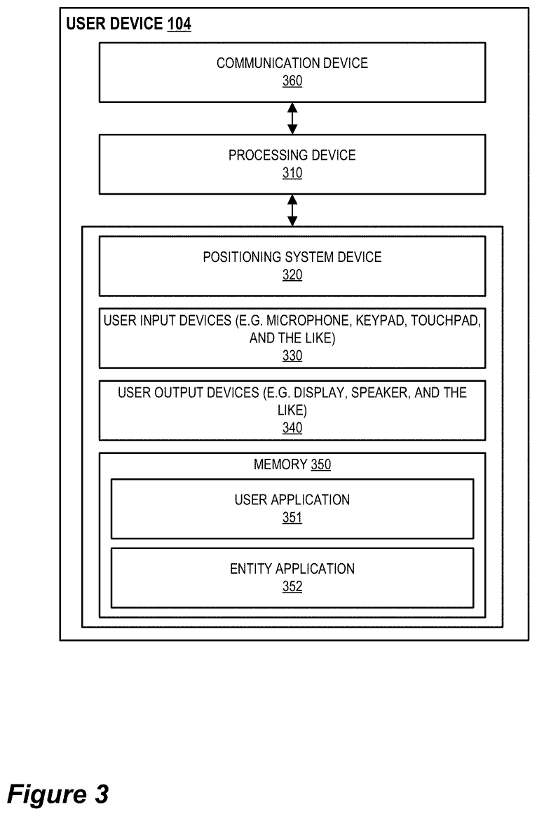

The user device 104 may comprise a mobile communication device, such as a cellular telecommunications device (e.g., a smart phone or mobile phone, or the like), a computing device such as a laptop computer, a personal digital assistant (PDA), a mobile internet accessing device, or other mobile device including, but not limited to portable digital assistants (PDAs), pagers, mobile televisions, laptop computers, cameras, video recorders, audio/video player, radio, GPS devices, any combination of the aforementioned, or the like. The user device is described in greater detail with respect to FIG. 3.

The managing entity system 500 may comprise a communication module and memory not illustrated, and may be configured to establish operative communication channels with a third party system 400 and/or a user device 104 via a network 101. The managing entity may comprise a data repository 256. The data repository 256 may contain resource account data, and may also contain user data. This user data may be used by the managing entity to authorize or validate the identity of the user 102 for accessing the system (e.g., via a username, password, biometric security mechanism, two-factor authentication mechanism, or the like). In some embodiments, the managing entity system is in operative communication with the secure resource system 200 and database 300 via a private communication channel. The private communication channel may be via a network 101 or the secure resource system 200 and database 300 may be fully integrated within the managing entity system 500, such as a virtual private network (VPN), or over a secure socket layer (SSL).

The managing entity system 500 may communicate with the secure resource system 200 in order to transmit data associated with observed or received data from or via a plurality of third party systems 400. In some embodiments, the managing entity system 500 may utilize the features and functions of the secure resource system 200 to initialize advisory measures in response to identifying data protection deficiencies. In other embodiments, the managing entity and/or the one or more third party systems 400 may utilize the secure resource system 200 to react to identified trends, patterns, or potential issues.

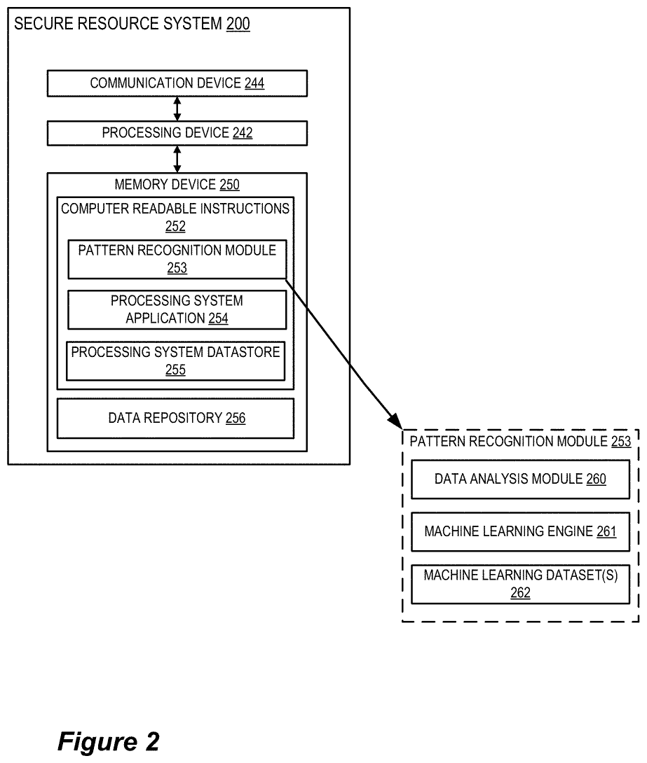

FIG. 2 illustrates a block diagram of the secure resource system 200 associated with the operating environment 100, in accordance with embodiments of the present invention. As illustrated in FIG. 2, the secure resource system 200 may include a communication device 244, a processing device 242, and a memory device 250 having a pattern recognition module 253, a processing system application 254 and a processing system datastore 255 stored therein. As shown, the processing device 242 is operatively connected to and is configured to control and cause the communication device 244, and the memory device 250 to perform one or more functions. In some embodiments, the pattern recognition module 253 and/or the processing system application 254 comprises computer readable instructions that when executed by the processing device 242 cause the processing device 242 to perform one or more functions and/or transmit control instructions to the database 300, the managing entity system 500, or the communication device 244. It will be understood that the pattern recognition module 253 or the processing system application 254 may be executable to initiate, perform, complete, and/or facilitate one or more portions of any embodiments described and/or contemplated herein. The pattern recognition module 253 may comprise executable instructions associated with data processing and analysis and may be embodied within the processing system application 254 in some instances. The secure resource system 200 may be owned by, operated by and/or affiliated with the same managing entity that owns or operates the managing entity system 500. In some embodiments, the secure resource system 200 is fully integrated within the managing entity system 500.

It is further understood that the secure resource system 200 is also scalable, meaning the it relies on multi-nodal system for batch processing, data retrieval, reporting, or the like. As such, the secure resource system 200 may be upgraded by adding or reducing the number of nodes active within the system in order to optimize efficiency and speed. In some embodiments, the multi-nodal nature of the system may also add to the integrity of the system output, where various machine learning models may be applied via different nodes on the same data set, and later analyzed against one another to determine a consensus or optimize the accuracy of data reporting. A multi-nodal approach also allows the secure resource system 200 to be less vulnerable. For instance, each node may be schedule for maintenance at different intervals to avoid total system downtime, and each node may be taken offline in the event of a node failure without compromising access to the system's capabilities.

The pattern recognition module 253 may further comprise a data analysis module 260, a machine learning engine 261, and a machine learning dataset(s) 262. The data analysis module 260 may store instructions and/or data that may cause or enable the secure resource system 200 to receive, store, and/or analyze data received by the managing entity system 500 or the database 300, as well as generate information and transmit responsive data to the managing entity system 500 in response to one or more requests or via a data stream between the secure resource system 200 and the managing entity system 500. The data analysis module may pre-process data before it is fed to the machine learning engine 261. In this way, the secure resource system 200 may exercise control over relevance or weighting of certain data features, which in some embodiments may be determined based on a metadata analysis of machine learning engine 261 output over time as time-dependent data is changed. In some embodiments, the pattern recognition module 253 may execute an image validation by combining the capabilities of a pre-trained machine learning model through representational state transfer (REST) and remote procedure call (RPC) application programming interfaces (APIs) with speeded up robust features (SURF) algorithms. Data fed to the pattern recognition module and data analysis module may be used to determine validations of one or more resource distributions from a user wishing to initiate a resource distribution.

For instance, in some embodiments, the data analysis module may receive a number of data files containing metadata which identifies the files as originating from a specific source application, containing certain data fields, or signifying certain transaction types, device types, authentication measures, merchants, sellers, users, or the like, and may package this data to be analyzed by the machine learning engine 261, as well as store the files in a catalog of data files in the data repository 256 or database 300 (e.g., files may be catalogued according to any metadata characteristic, including descriptive characteristics such as source, identity, content, data field types, or the like, or including data characteristics such as file type, size, encryption type, obfuscation, access rights, or the like). The machine learning engine 261 and machine learning dataset(s) 262 may store instructions and/or data that cause or enable the secure resource system 200 to generate, based on received information, new output in the form of a confidence score that a resource distribution request is a valid submission from an authorized user associated with a particular resource account. In some embodiments, the machine learning engine 261 and machine learning dataset(s) 262 may store instructions and/or data that cause or enable the secure resource system 200 to determine recommended actions for resolution of resource transfer failure or partial failure, determine access limitations or authorization privileges, or determine prophylactic actions to be taken to benefit one or more specific users or systems for their protection or privacy.

The machine learning dataset(s) 262 may contain data queried from database 300 or may be extracted or received from third party systems 400, managing entity system 500, or the like, via network 101. The database 300 may also contain metadata, which may be generated at the time of data creation, onboarding to the managing entity system 500 or secure resource system 200, or in some cases may be generated specifically by the data analysis module 260. In some cases, the metadata may include statistics regarding the data fields in each data set, which may be stored in a separate tabular dataset and tracked over a certain temporal period, such as a day, month, multi-month period, or the like, in order to provide the capability for meta-analysis on how data features affect modeling over time.

In some embodiments, the machine learning dataset(s) 262 may also contain data relating to user activity or device information, which may be stored in a user account managed by the managing entity system. In some embodiments, the machine learning engine 261 may be a single-layer recurrent neural network (RNN) which utilizes sequential models to achieve results in audio and textual domains. Additionally, the machine learning engine 261 may serve an alternate or dual purpose of analyzing user resource account history, user preferences, user interests, user device activity history, or other user submitted or gathered data from managing entity system 500, third party system 400, or the like, in order to generate predictions as to the statistical certainty that certain resource transactions, user device behavior, user communications, or the like, will be successful or are being validly authenticated. In some embodiments, this determination may be further based on situational characteristics, such as devices in the user's vicinity, or a location, time, or other contextual factors that may be analyzed in light of the user's past resource account history and device history.

For instance, the machine learning engine may consist of a multilayer perceptron neural network, recurrent neural network, or a modular neural network designed to process input variables related to one or more user characteristics and output recommendations or predictions. Given the nature of the managing entity system 500, particularly in embodiments where the managing entity system 500 is a financial institution, the machine learning engine 261 may have a large dataset of user account information, resource transaction information, account resource amount information, communication information, merchant information, data on known patterns for resource transactions on multiple payment channels, or the like, from which to draw from and discern specific patterns or correlations in device behavior, network communications between devices, or the like. It is understood that such data may be anonymized or completely stripped of personal identifying characteristics of specific users in preferred embodiments, with no negative impact the system's ability to generate accurate output or prediction data given certain variables.

In further embodiments, the machine learning engine 261 may have one or more data sets containing user account information, user communication pattern information, resource transaction information, account resource amount information, account access information, user authorization information, situational data, user interaction information, or the like, from which to draw from and discern specific patterns or correlations related to account security, system security, or the like. For instance, the machine learning engine 261 may be trained on a large dataset of exemplary data in order to based its determinations on (e.g., the machine learning engine 261 may adapt over time to accurately and precisely identify data fields within data sets that contain accurate or necessary information for successful resource transfers, or the like). As such, it is imperative that the machine learning engine 261 operate in an accurate and predictable manner, and the model must have the capability to dynamically adapt over time in response to changing data characteristics. However, if one feature set of the incoming data stream is skewing the output of the machine learning engine 261, it is necessary for the system to discern if the skew is natural or otherwise perhaps an intentionally levied method against the system in order to train the model to react to patterns or characteristics in a certain way. In such situations, the analysis of metadata in conjunction with machine learning output in order to identify feature sets which have the highest degree of impact on machine learning output over time may be most crucial, and the machine learning mode may need to be adjusted accordingly.

The machine learning engine 261 may receive data from a plurality of sources and, using one or more machine learning algorithms, may generate one or more machine learning datasets 262. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. It is understood that additional or alternative machine learning algorithms may be used without departing from the invention.

The communication device 244 may generally include a modem, server, transceiver, and/or other devices for communicating with other devices on the network 101. The communication device 244 may be a communication interface having one or more communication devices configured to communicate with one or more other devices on the network 101, such as the secure resource system 200, the user device 104, other processing systems, data systems, etc. Additionally, the processing device 242 may generally refer to a device or combination of devices having circuitry used for implementing the communication and/or logic functions of the secure resource system 200. For example, the processing device 242 may include a control unit, a digital signal processor device, a microprocessor device, and various analog-to-digital converters, digital-to-analog converters, and other support circuits and/or combinations of the foregoing. Control and signal processing functions of the secure resource system 200 may be allocated between these processing devices according to their respective capabilities. The processing device 242 may further include functionality to operate one or more software programs based on computer-executable program code 252 thereof, which may be stored in a memory device 250, such as the processing system application 254 and the pattern recognition module 253. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 242 may be configured to use the network communication interface of the communication device 244 to transmit and/or receive data and/or commands to and/or from the other devices/systems connected to the network 101.

The memory device 250 within the secure resource system 200 may generally refer to a device or combination of devices that store one or more forms of computer-readable media for storing data and/or computer-executable program code/instructions. For example, the memory device 250 may include any computer memory that provides an actual or virtual space to temporarily, or permanently, store data and/or commands provided to the processing device 242 when it carries out its functions described herein.

FIG. 3 is a block diagram illustrating a user device associated with the self correction system, in accordance with one embodiment of the present disclosure. The user device 104 may include a user mobile device, desktop computer, laptop computer, or the like. A “mobile device” 104 may be any mobile communication device, such as a cellular telecommunications device (i.e., a cell phone or mobile phone), personal digital assistant (PDA), a mobile Internet accessing device, or another mobile device including, but not limited to portable digital assistants (PDAs), pagers, mobile televisions, laptop computers, cameras, video recorders, audio/video player, radio, GPS devices, any combination of the aforementioned devices. The user device 104 may generally include a processing device or processor 310 communicably coupled to devices such as, a memory device 350, user output devices 340 (for example, a user display or a \speaker), user input devices 330 (such as a microphone, keypad, touchpad, touch screen, and the like), a communication device or network interface device 360, a positioning system device 320, such as a geo-positioning system device like a GPS device, an accelerometer, and the like, one or more chips, and the like.

The processor 310 may include functionality to operate one or more software programs or applications, which may be stored in the memory device 350. For example, the processor 310 may be capable of operating applications such as a user application 351, an entity application 352, or a web browser application. The user application 351 or the entity application may then allow the user device 104 to transmit and receive data and instructions to or from the third party system 400, secure resource system 200, and the managing entity system 500, and display received information via the user interface of the user device 104. The user application 351 may further allow the user device 104 to transmit and receive data to or from the managing entity system 500 data and instructions to or from the secure resource system 200, web content, such as, for example, location-based content and/or other web page content, according to a Wireless Application Protocol (WAP), Hypertext Transfer Protocol (HTTP), and/or the like. The user application 351 may allow the managing entity system 500 to present the user 102 with a plurality of recommendations, identified trends, suggestions, transaction data, pattern data, graph data, statistics, and/or the like for the user to review. In some embodiments, the user interface displayed via the user application 351 or entity application 352 may be entity specific. For instance, while the secure resource system 200 may be accessed by multiple different entities, it may be configured to present information according to the preferences or overall common themes or branding of each entity system of third party system. In this way, each system accessing the secure resource system 200 may use a unique aesthetic for the entity application 352 or user application 351 portal.

The processor 310 may be configured to use the communication device 360 to communicate with one or more devices on a network 101 such as, but not limited to the third party system 400, the secure resource system 200, and the managing entity system 500. In this regard the processor 310 may be configured to provide signals to and receive signals from the communication device 360. The signals may include signaling information in accordance with the air interface standard of the applicable BLE standard, cellular system of the wireless telephone network and the like, that may be part of the network 101. In this regard, the user device 104 may be configured to operate with one or more air interface standards, communication protocols, modulation types, and access types. By way of illustration, the user device 104 may be configured to operate in accordance with any of a number of first, second, third, and/or fourth-generation communication protocols and/or the like. For example, the user device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user device 104 may also be configured to operate in accordance with non-cellular communication mechanisms, such as via a wireless local area network (WLAN) or other communication/data networks. The user device 104 may also be configured to operate in accordance Bluetooth® low energy, audio frequency, ultrasound frequency, or other communication/data networks.

The communication device 360 may also include a user activity interface presented in user output devices 340 in order to allow a user 102 to execute some or all of the processes described herein. The application interface may have the ability to connect to and communicate with an external data storage on a separate system within the network 101. The user output devices 340 may include a display (e.g., a liquid crystal display (LCD) or the like) and a speaker or other audio device, which are operatively coupled to the processor 310 and allow the user device to output generated audio received from the secure resource system 200. The user input devices 330, which may allow the user device 104 to receive data from the user 102, may include any of a number of devices allowing the user device 104 to receive data from a user 102, such as a keypad, keyboard, touch-screen, touchpad, microphone, mouse, joystick, other pointer device, button, soft key, and/or other input device(s).

The user device 104 may also include a memory buffer, cache memory or temporary memory device 350 operatively coupled to the processor 310. Typically, one or more applications 351 and 352, are loaded into the temporarily memory during use. As used herein, memory may include any computer readable medium configured to store data, code, or other information. The memory device 350 may include volatile memory, such as volatile Random Access Memory (RAM) including a cache area for the temporary storage of data. The memory device 350 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the secure resource system 200 performing one or more steps described herein in conjunction with other devices and systems, either automatically based on executing computer readable instructions of the memory device 250, or in response to receiving control instructions from the managing entity system 500. In some instances, the system refers to the devices and systems on the operating environment 100 of FIG. 1.

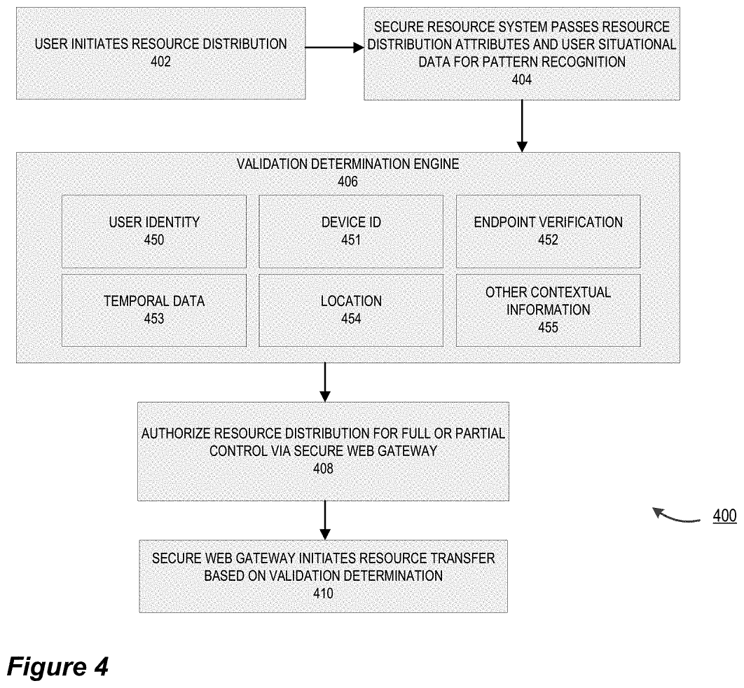

FIG. 4 is a process flow diagram illustrating a process for secure validation of unrestricted resource distribution, in accordance with one embodiment of the present disclosure. As used herein, the term unrestricted resource distribution refers to a resource distribution, or transfer of funds, as a form of payment, which is not subject to one or more typical limits typically placed on a user by a payment processing entity, government entity, or the like. As such, the unrestricted resource distribution may represent a sum of resources that the user authorizes or attempts to initiate transfer of to a particular recipient for goods or services. In other instances, the unrestricted resource distribution may be a form of automatic resource distribution that occurs on a regular basis (e.g., with a certain frequency over a period of days, weeks, months, or the like), and as such, a durable validation approach is warranted to allow a merchant, payment processor, or the like to have full or partial control in processing one or more unrestricted resource distributions. Unrestricted resource distributions may be processed, in some embodiments, by the entity which controls and manages the secure resource system 200, while in other embodiments, the secure resource system 200 may communicate with, or coordinate with, one or more third party systems 400 as needed, depending on the recipient of the resources, location of the recipient of the resources, or the like. A validation engine 406 is responsible for providing validation of unrestricted resource distributions, sometimes just referred to as resource distributions. In some embodiments, the validation engine 406 may expedite a determination of validation if one or more characteristics of a resource distribution relates closely to a previously authorized unrestricted resource distribution from the same user, device, or the like. As such, the validation engine 406 is situationally aware and may increase efficiency of processing based on patterns and trends observed over time by the secure resource system 200. It is understood that in preferred embodiments, the user may initiate an unrestricted resource distribution via any internet of things (IoT) device, which provides convenience to the user.

As shown, the process begins whereby the user initiates a resource distribution, as shown in block 402. The secure resource system forwards resource distribution attributes and user situational data for pattern recognition, to the validation determination engine 406, as shown in block 404. The validation determination engine may include particular features of the secure resource system 200, such as the pattern recognition module 253, which is designed and trained to analyze data received regarding resource distributions, user data, situational data, device data from devices near the near or owned by the user, network data, location data, or the like. In some embodiments, the validation determination engine 406 may utilize data such as user identity 405, device identification number (ID) 451, endpoint verification 452, temporal data 453 (such as timestamp, or the like), location 454, or other contextual information 455 (e.g., nearby device data, resource distribution history, user resource account history, merchant information, special offer information, payment instrument, communication channel metadata, or the like).

The validation determination engine 406 may process one or more validations that may be categorized in a number of ways. For instance, the validation engine 406 may execute an image validation by combining the capabilities of a pre-trained machine learning model through representational state transfer (REST) and remote procedure call (RPC) application programming interfaces (APIs) with speeded up robust features (SURF) algorithms. The validation engine 406 may also execute an identity verification based on customer or user data obtained from the user or pre-existing on entity storage systems as compared to data being received from one or more user devices in real time, or near-real time. In other instances, the validation engine 406 may execute a device validation, such as comparing a device ID to a known user device ID, or utilizing the capabilities of one or more user devices to conduct a biometric authentication using a security chip on the user device as a form of authentication. The validation engine 406 may also conduct various endpoint authentications, such as a two-factor authentication, use of a three-way handshake mechanism or secure socket layer protocol, use of an encrypted channel of communication with a pre-shared key, verification of one or more security or web address certificates, or the like, in order to identify that the user device is secure, being utilized by the purported user, and also that the recipient of the resource distribution is verified (e.g., a merchant, website, or the like). In still further embodiments, the validation engine 406 may use a geolocation identification, based on the location data received from one or more user devices, in order to determine if the user is in an expected or typical location based on their transaction history, user data, device data, or the like. Other contextual validations may be processed by the validation engine 406 such as one time processing (OTP) validations, and this may be required only when the resource amount for the unrestricted resource distribution is very high, image validation is partial, or other partial successes are determined by the validation engine 406 using the approaches described herein.

If the validation engine 406 can successfully processes a validation based on the multiple factors described, the secure resource system 200 may authorize resource distribution for full or partial control via a secure web gateway (SWG), such as a cyberbarrier or checkpoint that keeps unauthorized traffic from entering, or accessing device on, the network of the secure resource system 200. The SWG only allows users to access approved, secure users or systems, while others are blocked, and access by payment processors via the SWG will depend on each set of results from the validation engine 406. Based on control given to the SWG recipient or resource distribution processor, the SWG will initiate resource distribution, and a payment may be processed.

It is understood that the servers, systems, and devices described herein illustrate one embodiment of the invention. It is further understood that one or more of the servers, systems, and devices can be combined in other embodiments and still function in the same or similar way as the embodiments described herein.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined, or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for secure validation of unrestricted resource distribution, the system comprising:
a memory device; and
a processing device operatively coupled to the memory device, wherein the processing device is configured to execute computer-readable program code to:
receive a request from a user device to validate a resource distribution;
forward one or more request attributes to a validation engine for pattern recognition and resource distribution authentication;
analyze and compare the one or more request attributes via the validation engine to determine if the resource distribution is partially or fully validated based on comparison to historical user or device data and one or more contextual validation factors; and
based on determining that the resource distribution is partially or fully validated, automatically process the resource distribution via a secure web gateway.

2. The system of claim 1, further comprising determining that the resource distribution is above a pre-defined threshold limit for automatic processing prior to initiating further processing via the validation engine.

3. The system of claim 1, wherein the user device is an internet-of-things device, such as a smart home assistant, home appliance, or entertainment device.

4. The system of claim 1, wherein the request attributes further comprise a resource amount, a resource recipient, a frequency of repetition, a user resource account, a resource distribution channel, and a resource type.

5. The system of claim 1, further comprising transmitting a notification to the user device upon a determination that the resource distribution is partially or fully validated.

6. The system of claim 1, further comprising determining that the resource distribution is above a pre-defined amount threshold prior to validation; and
removing the pre-defined threshold based on determining that the resource distribution is partially or fully validated.

7. The system of claim 1, wherein the validation engine is a machine learning model trained to conduct image validation.

8. A computer program product for secure validation of unrestricted resource distribution, the computer program product comprising a non-transitory computer-readable medium comprising code causing a first apparatus to:
receive a request from a user device to validate a resource distribution;
forward one or more request attributes to a validation engine for pattern recognition and resource distribution authentication;
analyze and compare the one or more request attributes via the validation engine to determine if the resource distribution is partially or fully validated based on comparison to historical user or device data and one or more contextual validation factors; and
based on determining that the resource distribution is partially or fully validated, automatically process the resource distribution via a secure web gateway.

9. The computer program product of claim 8, further comprising code causing a first apparatus to determine that the resource distribution is above a pre-defined threshold limit for automatic processing prior to initiating further processing via the validation engine.

10. The computer program product of claim 8, wherein the user device is an internet-of-things device, such as a smart home assistant, home appliance, or entertainment device.

11. The computer program product of claim 8, wherein the request attributes further comprise a resource amount, a resource recipient, a frequency of repetition, a user resource account, a resource distribution channel, and a resource type.

12. The computer program product of claim 8, further comprising code causing a first apparatus to transmit a notification to the user device upon a determination that the resource distribution is partially or fully validated.

13. The computer program product of claim 8, further comprising code causing a first apparatus to determine that the resource distribution is above a pre-defined amount threshold prior to validation; and
remove the pre-defined threshold based on determining that the resource distribution is partially or fully validated.

14. The computer program product of claim 8, wherein the validation engine is a machine learning model trained to conduct image validation.

15. A computer-implemented method for secure validation of unrestricted resource distribution, the method comprising:
receiving a request from a user device to validate a resource distribution;
forwarding one or more request attributes to a validation engine for pattern recognition and resource distribution authentication;
analyzing and compare the one or more request attributes via the validation engine to determine if the resource distribution is partially or fully validated based on comparison to historical user or device data and one or more contextual validation factors; and
based on determining that the resource distribution is partially or fully validated, automatically processing the resource distribution via a secure web gateway.

16. The computer-implemented method of claim 15, further comprising determining that the resource distribution is above a pre-defined threshold limit for automatic processing prior to initiating further processing via the validation engine.

17. The computer-implemented method of claim 15, wherein the user device is an internet-of-things device, such as a smart home assistant, home appliance, or entertainment device.

18. The computer-implemented method of claim 15, wherein the request attributes further comprise a resource amount, a resource recipient, a frequency of repetition, a user resource account, a resource distribution channel, and a resource type.

19. The computer-implemented method of claim 15, further comprising transmitting a notification to the user device upon a determination that the resource distribution is partially or fully validated.

20. The computer-implemented method of claim 15, further comprising determining that the resource distribution is above a pre-defined amount threshold prior to validation; and
removing the pre-defined threshold based on determining that the resource distribution is partially or fully validated.
